(19) United States
(12) Patent Application Publication
(10) Pub. No.: US 2020/0265434 A1
(43) Pub. Date: Aug. 20, 2020

(54) TRANSACTION AUTHENTICATION METHOD

(71) Applicant: WALTON ADVANCED ENGINEERING INC., Kaohsiung (TW)

(72) Inventors: Hong Chi YU, Kaohsiung (TW); Mao Ting CHANG, Kaohsiung (TW)

(73) Assignee: WALTON ADVANCED ENGINEERING INC., Kaohsiung (TW)

(21) Appl. No.: 16/367,349

(22) Filed: Mar. 28, 2019

(30) Foreign Application Priority Data
Feb. 19, 2019 (TW) 108105488

(51) Int. Cl. G06Q 20/40; G06Q 20/32; G06Q 20/08

(52) U.S. Cl. CPC G06Q 20/4014; G06Q 20/0855; G06Q 20/3255

(57) ABSTRACT

The present disclosure relates to a transaction authentication method in which a process for transaction safety is created: a consumption confirmation is sent to an authentication box from a transaction platform on which a user has a customer behavior through the internet; the authentication box notifies the user based on a default configuration; the user replies the authentication box by confirmed information; a dedicated confirmation code is replied to the transaction platform from the authentication box and the customer behavior of the user is approved by the transaction platform.

### BACKGROUND OF THE INVENTION

### 1) Field of the Invention

The preset disclosure relates to a method protecting transaction information, particularly a method based on an authentication box which coordinates with a consumer to check validity of a transaction and authenticates a correct transaction made on a transaction platform that is connected to the authentication box via the internet.

### 2) Description of the Prior Art

The consumers can purchase almost all merchandises in the world at their fingertips through convenient on-line transactions or mobile payments sought-after in the current society at homes or offices rather than brick-and-mortar stores.

However, blessings never come in pairs because those malicious attacks on on-line transactions go viral. A user who is carrying on an on-line transaction probably opens a Pandora's box from which all kind of threats to be blocked with caution particularly such as fake website, malicious redirection, forged security seal and Trojan dropper are released.

The patent documentations with respect to transaction security are shown as follows:

U.S. Ser. No. 14/806,219 discloses a mobile checkout system and method for completing a purchase transaction to buy items from an internet merchant. A user browses and selects items for purchases from the merchant through a shopping application or browser. During processing of a transaction, a checkout application installed on a mobile communication device is launched. The checkout application receives a checkout token created by a checkout server that identifies a purchase transaction. The checkout application using the token communicates with the checkout server in which a purchase transaction is completed and encrypted data with respect to payment is securely transmitted.

China Patent CN 201210530382.X discloses a method controlling accounts of an online transaction platform, which is characterized in that: leveled control functions are divided into at least two layers, each of which features single or multiple functions and corresponds to a security authentication, and provided to a user account; a leveled control function is activated or authorized for the user account; a leveled control function for one layer is activated for the user account as required after the login step for the user account is completed and a request to access the layer from the user account for which security authentication has been checked is received; the status of a layer activated is continued until the user logs out of the online transaction platform or the activated layer for the user account is disabled. Moreover, a device and a server to control an on-line transaction platform are also provided in CN 201210530382.X.

R.O.C. Patent TW 1541739 discloses an on-line transaction & payment system and a payment process, both of which rely on a mobile device (or a computer) with an image scanning module to complete a login step of a network platform and browse web pages by a consumer. A purchase for selected merchandise should be paid for by a consumer at a payment tool through a barcode, texts and digits. Before the payment of a consumer from the payment tool, the barcode on the payment tool is scanned by the image scanning module and transmitted to a network platform on which the correct and valid payment tool is checked and authenticated; then, an amount corresponding to the merchandise is deducted through the payment tool for completion of a payment process. Accordingly, a payment is based on a barcode on a payment tool with neither a consumer's personal data provided nor the payment made at a brick-and-mortar store for better convenience and safety of payment.

However, how to protect safety of a transaction process without personal information spilled from a transaction platform is still defective. In the present disclosure, a transaction authentication method is provided for least problems mentioned previously.

### SUMMARY OF THE INVENTION

In virtue of the above problem, a transaction authentication method provided in the present disclosure is based on an authentication box for safety of cash flow information.

Accordingly, a transaction authentication method provided in the present disclosure relies on an authentication box with which a user's traction behavior is authenticated for validity of a transaction.

A transaction authentication method provided in the present disclosure relies on an authentication box with which a cash flow transaction is carried on for no transaction-related information filched from a transaction platform.

A transaction authentication method provided in the present disclosure relies on an authentication box in which transaction-related data is saved for a simplified transaction process and safety.

A transaction authentication method provided in the present disclosure relies on an authentication box from which temporary cash flow information for a transaction is given for no transaction-related data preserved in a transaction platform.

To this end, a transaction authentication method is embodied according to the following technical measures. A transaction authentication method in the present disclosure comprises: step 1: a consumption confirmation is sent to an authentication box from a transaction platform on which a user has a customer behavior through the internet; step 2: the authentication box notifies the user based on a default configuration; step 3: the user replies the authentication box by confirmed information; step 4: a dedicated confirmation code is replied to the transaction platform from the authentication box and the customer behavior of the user is approved by the transaction platform.

A transaction authentication method is further embodied according to the following steps technically.

In the transaction authentication method, the default configuration in step 2 can be set as either a text message notification or an app notification.

In the transaction authentication method, the confirmed information in step 3 is replied through texting or activated from an application program.

In the transaction authentication method, correlations between the transaction platform and the authentication box are configured by the user before step 1.

In the transaction authentication method, the dedicated confirmation code comprises detailed credit card information.

In the transaction authentication method, a payment request for a customer behavior authenticated by the authentication box is submitted to a third-party platform after step 3.

In the transaction authentication method, a payment request for a customer behavior approved by the transaction platform is submitted to a third-party platform after step 4.

In the transaction authentication method, the third-party platform informs the transaction platform of completion of a payment process for the customer behavior in step 4 simultaneously.

In contrast to the prior art, a transaction authentication method in the present disclosure proves effective in: (1) relying on an authentication box to authenticate a user's transaction behavior for validity of a transaction; (2) relying on an authentication box to carry on a cash flow transaction for no transaction-related data filched from a transaction platform; (3) relying on an authentication box to save transaction-related data for a transaction process simplified and safety.

### BRIEF DESCRIPTIONS OF THE DRAWINGS

FIG. 1a is the first flowchart for a transaction authentication method in the first embodiment;

FIG. 1b is the second flowchart for a transaction authentication method in the first embodiment;

FIG. 2 is a flowchart for a transaction authentication method in the second embodiment;

FIG. 3a is the first flowchart for a transaction authentication method in the third embodiment;

FIG. 3b is the second flowchart for a transaction authentication method in the third embodiment;

FIG. 4 is a flowchart for a transaction authentication method in the fourth embodiment;

FIG. 5a is the first schematic view for a transaction authentication method in a preferred embodiment;

FIG. 5b is the second schematic view for a transaction authentication method in a preferred embodiment;

FIG. 5c is the third schematic view for a transaction authentication method in a preferred embodiment;

FIG. 5d is the fourth schematic view for a transaction authentication method in a preferred embodiment;

FIG. 5e is the fifth schematic view for a transaction authentication method in a preferred embodiment;

FIG. 5f is the sixth schematic view for a transaction authentication method in a preferred embodiment;

FIG. 5g is the seventh schematic view for a transaction authentication method in a preferred embodiment.

### DETAILED DESCRIPTIONS OF THE PREFERRED EMBODIMENTS

A transaction authentication method is explained in the preferred embodiment for clear understanding of purposes, characteristics and effects of the present disclosure.

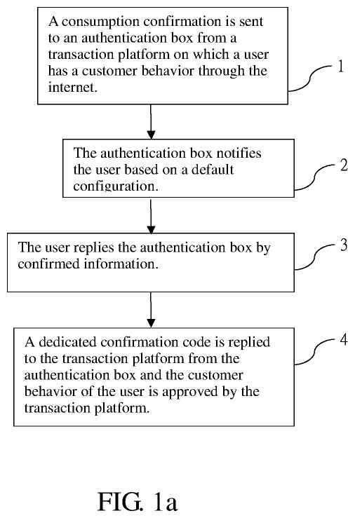

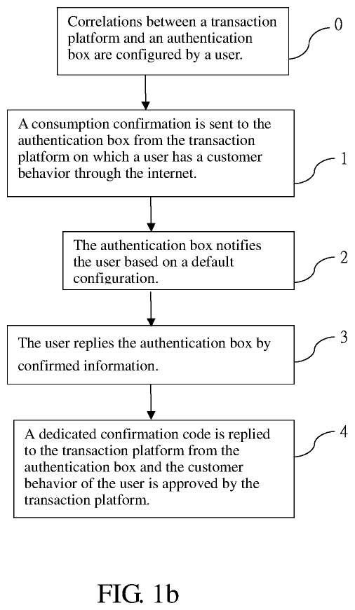

Referring to FIG. 1a, which illustrates a transaction authentication method in the first embodiment comprises step 1 (1), step 2 (2), step 3 (3) and step 4 (4).

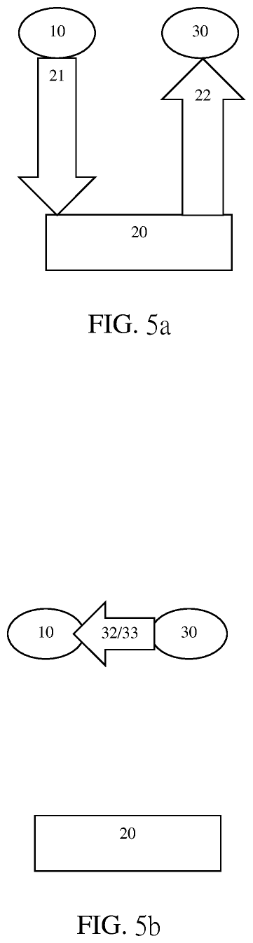

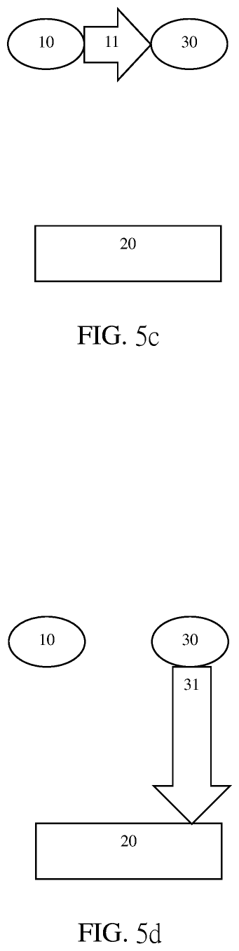

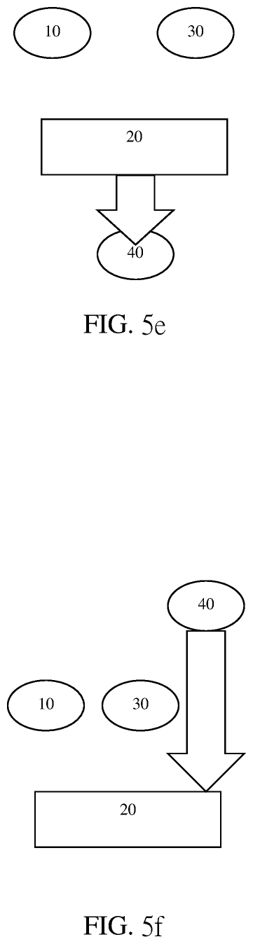

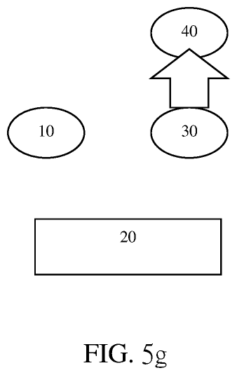

Referring to FIG. 1a for step 1 (1) and FIG. 5a, which illustrate a consumption confirmation (22) is sent to an authentication box (30) from the transaction platform (20) on which a user (10) has a customer behavior (21) through the internet in step 1 (1).

In general, the user (10) is defined as a person who intends to conduct the customer behavior (21) and pay money for the customer behavior (21); the transaction platform (20) is a network platform through which merchandises are transacted, a connection to the internet is enabled and transaction status is confirmed; the customer behavior (21) means a purchase behavior for a selected merchandise occurring on the transaction platform (20) and waiting to be confirmed but not paid for; the authentication box (30) to which an internet connection is available is used to save cash flow information of a user (10) in advance for safe authentication as well as limited safety connection; the consumption confirmation (22) sent from the transaction platform (20) should be double checked by the user (10) and authenticated by the authentication box (30).

Referring to FIG. 1a for step 2 (2) and FIG. 5b, which illustrate the authentication box (30) notifies the user (10) based on a default configuration in step 2 (2).

As shown in FIGS. 1a and 5b, the default configuration in step 2 (2) can be set as either a text message notification (32) or an app notification (33). Referring to FIG. 5b, which illustrates the text message notification (32) applicable in a scenario of a mobile communications device owned by the user (10) is only received by the user (10) through the phone number dedicated to the mobile communications device of the user (10); the app notification (33) is applicable in an appliance owned by the user (10), for example, a computer or a mobile device in which an application program is installed, and received by the application program with a network connection completed.

Then, referring to FIG. 1a for step 3 (3) and FIG. 5c, which illustrate the user (10) replies the authentication box (30) by confirmed information (11) in step 3 (3).

For the matter, the confirmed information (11) in step 3 (3) can be each of digits, English letters, random codes or voices, which are replied through texting, application program inputs or a phone call, and received by the authentication box (30) through a corresponding interface.

Finally, referring to FIG. 1a for step 4 (4) and FIG. 5d, which illustrate a dedicated confirmation code (31) is replied to the transaction platform (20) from the authentication box (30) and the customer behavior (21) of the user (10) is approved by the transaction platform (20) in step 4 (4).

Moreover, in step 4 (4), the dedicated confirmation code (31) is sent to the transaction platform (20) via the internet after a reply to the authentication box (30) from a user (10) in step 3 (3) is confirmed; in this regard, the dedicated confirmation code (31) corresponds to dedicated information of the consumption confirmation (22) and probably comprises a transaction result and transaction audit data.

In practice, step 0 (0) may be added in the first embodiment in advance; referring to FIG. 1b, which illustrates some correlations between the transaction platform (20) and the authentication box (30) are configured by the user (10) in step 0 (0).

For implementation of a transaction authentication method fast and convenient in the future, the trust relationships among the user (10), the transaction platform (20) and the authentication box (30) are created in advance in step 0 (0).

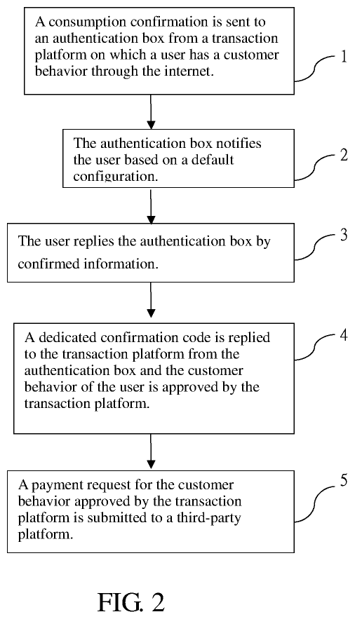

Referring to FIG. 2, which illustrates a transaction authentication method in the second embodiment in which the characteristics identical to those of the first embodiment in FIGS. 1a and 1b are not explained hereinafter. The difference in the second embodiment differing from the first embodiment is step 5 (5) after step 4 (4).

Referring to FIG. 2 for a flowchart of the second embodiment, which illustrates a transaction authentication method comprises step 1 (1), step 2 (2), step 3 (3), step 4 (4) and step 5 (5).

As shown in FIG. 2 for step 1 (1) and FIG. 5a, a consumption confirmation (22) is sent to the authentication box (30) from the transaction platform (20) on which a user (10) has a customer behavior (21) through the internet in step 1 (1).

Referring to FIG. 2 for step 2 (2) and FIG. 5b, which illustrate the authentication box (30) notifies the user (10) based on a default configuration in step 2 (2).

Referring to FIG. 2 for step 3 (3) and FIG. 5c, which illustrate the user (10) replies the authentication box (30) by confirmed information (11) in step 3 (3).

Referring to FIG. 2 for step 4 (4) and FIG. 5d, which illustrate a dedicated confirmation code (31) is replied to the transaction platform (20) from the authentication box (30) and the customer behavior (21) of the user (10) is approved by the transaction platform (20) in step 4 (4).

Finally, referring to FIG. 2 for step 5 (5) and FIG. 5e, which illustrate a payment request for the customer behavior (21) approved by the transaction platform (20) is submitted to a third-party platform (40) in step 5 (5).

Before execution of step 5 (5), the dedicated confirmation code (31) in step 4 (4) comprises detailed credit card information in advance by which a payment request for the customer behavior (21) is submitted to the third-party platform (40) in step 5 (5). With step 5 (5) completed, the detailed credit card information in the dedicated confirmation code (31) is not applicable in the transaction platform (20) but saved as temporary virtual credit card details.

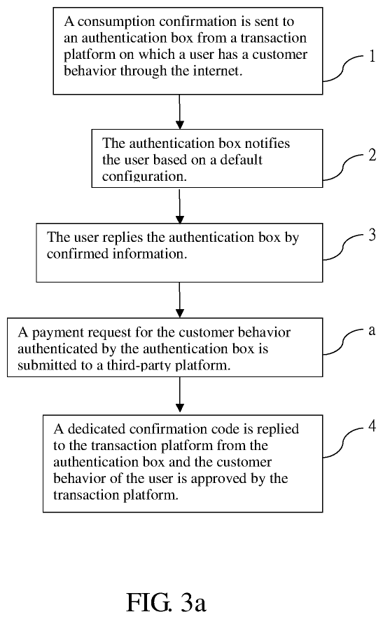

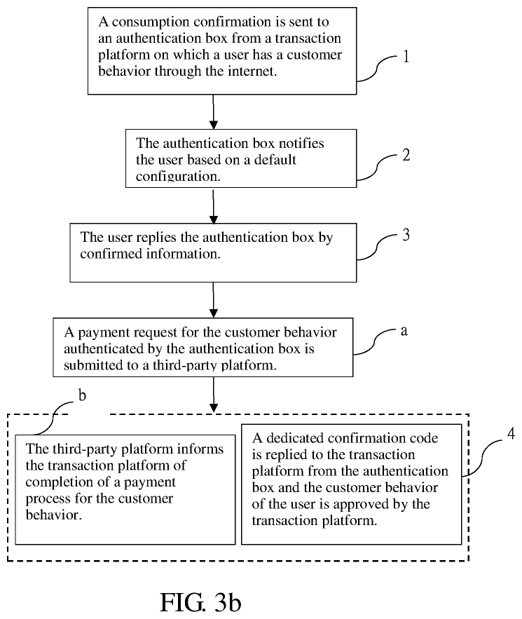

Referring to FIGS. 3a and 3b that illustrates a transaction authentication method in the third embodiment in which the characteristics identical to those of the first embodiment in FIGS. 1a and 1b are not explained hereinafter. The difference in the third embodiment differing from the first embodiment is step a (a) before step 4 (4).

Referring to FIG. 3a for a flowchart of the third embodiment, which illustrates a transaction authentication method comprises step 1 (1), step 2 (2), step 3 (3), step a (a) and step 4 (4).

As shown in FIG. 3a for step 1 (1) and FIG. 5a, a consumption confirmation (22) is sent to the authentication box (30) from the transaction platform (20) on which a user (10) has a customer behavior (21) through the internet in step 1 (1).

Referring to FIG. 3a for step 2 (2) and FIG. 5b, which illustrate the authentication box (30) notifies the user (10) based on a default configuration in step 2 (2).

Referring to FIG. 3a for step 3 (3) and FIG. 5c, which illustrate the user (10) replies the authentication box (30) by confirmed information (11) in step 3 (3).

Referring to FIG. 3a for step a (a) and FIG. 5g, which illustrate a payment request for the customer behavior (21) authenticated by the authentication box (30) is submitted to a third-party platform (40) in step a (a).

Furthermore, detailed information for a transaction made on the third-party platform (40) through the authentication box (30) like credit card details, account or cash flow in step a (a) is protected in the authentication box (30) and the third-party platform (40) only but not accessed from the transaction platform (20).

Finally, referring to FIG. 3a for step 4 (4) and FIG. 5d, which illustrate a dedicated confirmation code (31) is replied to the transaction platform (20) from the authentication box (30) and the customer behavior (21) of the user (10) is approved by the transaction platform (20) in step 4 (4).

Preferably, referring to FIGS. 3b and 5f that illustrate step 4 (4) is accompanied by step b (b) in which the third-party platform (40) informs the transaction platform (20) of completion of a payment process for the customer behavior (21). Accordingly, a payment is re-authenticated in step b (b) for better reliability of each transaction.

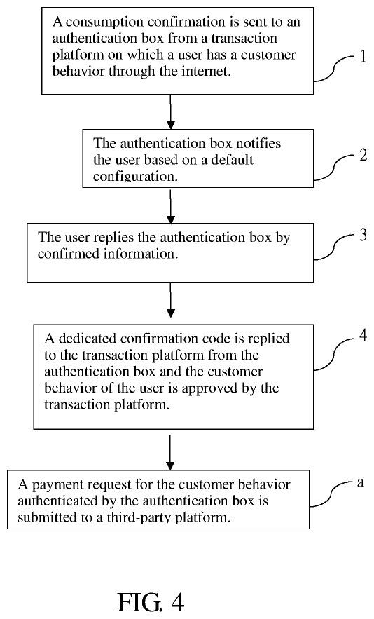

Referring to FIG. 4 that illustrates a transaction authentication method in the fourth embodiment in which the characteristics identical to those of the first embodiment in FIGS. 1a and 1b are not explained hereinafter. The difference in the fourth embodiment differing from the first embodiment is step a (a) after step 4 (4).

Referring to FIG. 4 for a flowchart of the fourth embodiment, which illustrates a transaction authentication method comprises step 1 (1), step 2 (2), step 3 (3), step 4 (4) and step a (a).

As shown in FIG. 4 for step 1 (1) and FIG. 5a, a consumption confirmation (22) is sent to the authentication box (30) from the transaction platform (20) on which a user (10) has a customer behavior (21) through the internet in step 1 (1).

Referring to FIG. 4 for step 2 (2) and FIG. 5b, which illustrate the authentication box (30) notifies the user (10) based on a default configuration in step 2 (2).

Referring to FIG. 4 for step 3 (3) and FIG. 5c, which illustrate the user (10) replies the authentication box (30) by confirmed information (11) in step 3 (3).

Referring to FIG. 4 for step 4 (4) and FIG. 5d, which illustrate a dedicated confirmation code (31) is replied to the transaction platform (20) from the authentication box (30) and the customer behavior (21) of the user (10) is approved by the transaction platform (20) in step 4 (4).

Finally, referring to FIG. 4 for step a (a) and FIG. 5g, which illustrate a payment request for the customer behavior (21) authenticated by the authentication box (30) is submitted to a third-party platform (40) in step a (a).

Furthermore, detailed information for a transaction made on the third-party platform (40) through the authentication box (30) like credit card details, account or cash flow in step a (a) is protected in the authentication box (30) and the third-party platform (40) only but not accessed from the transaction platform (20); on the other hand, the customer behavior (21) of the user (10) will be cancelled by the transaction platform (20) which received the message of a payment failed in step a (a) from the authentication box (30).

Accordingly, a transaction authentication method which is different from an ordinary on-line transaction method and referred to as creative work in applications of on-line transactions meets patentability and is applied for the patent.

It should be reiterated that the above descriptions present the preferred embodiments, and any equivalent changes in specifications, claims or drawings still belongs to the technical field within the present disclosure with reference to claims hereinafter.

1. A transaction authentication method, performed in a system comprising a transaction platform, an authentication box and a computer or mobile device, wherein the transaction platform is a network platform through merchandises are transacted and a connection to the internet is enabled and transaction status is confirmed, and wherein the authentication box, to which an internet connection is available, is used to pre-save a cash flow information of a user for safe authentication as well as limited safety connection,
the method comprising steps as follows:
step 0: configuring, by a user, correlations between the transaction platform and the authentication box;
step 1: a consumption confirmation is sent to the authentication box from the transaction platform on which the user has a customer behavior through the internet;
step 2: the authentication box notifies the user by the application program;
step 3: the user replies to the authentication box by application program inputs as confirmed information received by the authentication box through a corresponding interface;
step 4: a dedicated confirmation code is replied to the transaction platform from the authentication box and the customer behavior of the user is approved by the transaction platform.

2. The transaction authentication method as claimed in claim 1 wherein the default configuration in step 2 can be set as either a text message notification or an app notification.

3. The transaction authentication method as claimed in claim 2 wherein the confirmed information in step 3 is replied through texting or activated from an application program.

4. The transaction authentication method as claimed in claim 1 wherein correlations between the transaction platform and the authentication box are configured by the user before step 1.

5. The transaction authentication method as claimed in claim 1 wherein the dedicated confirmation code comprises detailed credit card information.

6. The transaction authentication method as claimed in claim 1 wherein a payment request for a customer behavior authenticated by the authentication box is submitted to a third-party platform after step 3.

7. The transaction authentication method as claimed in claim 1 wherein a payment request for a customer behavior approved by the transaction platform is submitted to a third-party platform after step 4.

8. The transaction authentication method as claimed in claim 6 wherein the third-party platform informs the transaction platform of completion of a payment process for the customer behavior in step 4 simultaneously.
